(19) United States
(12) Patent Application Publication
(10) Pub. No.: US 2014/0191975 A1
(43) Pub. Date: Jul. 10, 2014

(54) ELECTRONIC DEVICE AND INPUT METHOD THEREOF

(71) Applicant: HTC CORPORATION, Taoyuan County (TW)

(72) Inventor: Peter Chou, Taoyuan County (TW)

(73) Assignee: HTC CORPORATION, Taoyuan County (TW)

(21) Appl. No.: 13/733,904

(22) Filed: Jan. 4, 2013

(51) Int. Cl. G06F 3/041

(52) U.S. Cl. CPC G06F 3/041
USPC 345/171; 345/168

(57) ABSTRACT

An electronic device for a segmental writing including a touch screen is provided. The touch screen is configured to: receive a first touch signal of touching a consonant key; display at least one predicted units in response to the first touch signal; receive a second touch signal of touching an expanding key in a temporary display region; display the predicted units in response to the second touch signal; receive a third touch signal of touching one of the predicted units; and display the touched predicted unit in response to the third touch signal.

### BACKGROUND OF THE INVENTION

1. Field of the Invention

The present invention relates to an electronic device and an input method thereof, in particular, to an electronic device and an input method thereof for a segmental writing.

2. Description of Related Art

With the continuous progress of input apparatus technique, there is a trend for manufacturers of electronic products such as conventional electronic input apparatuses and portable multimedia players to use touch screens as a new-generation input interfaces to replace conventional physical keypads. Taking a cell phone as an example, the user when operating an electronic device with a keypad must read the picture displayed on the screen while pressing the keypad, so as to successfully finish operations such as word inputting or menu switching. However, if a touch screen is applied in the electronic device, the user can directly finish operations of word inputting or activating application programs by simply clicking with a stylus or directly pressing with his finger on the screen. Therefore, the touch screen provides a more flexible and convenient input manner.

An abugida, also called an alphasyllabary, is a segmental writing system in which consonant-vowel sequences are written as a unit, i.e., each unit is based on a consonant letter and vowel notation is secondary. The word “alphasyllabary” comes from “syllabic alphabet” which consists of symbols for consonant letters and vowel notations. The consonant letters each has an inherent vowel which can be changed to another vowel or muted by means of diacritics. Vowel notations can also be written with separate letters when they occur at the beginning of a word or on their own. When two or more consonant letters occur together, special conjunct symbols, sometimes they are vowel notations, are often used which add the essential parts of first letter or letters in the sequence to the final letter. Most languages of Southeast Asia countries use abugida, for example Burmese language (or Myanmar language), Thai language, Lao language, or the like.

Taking Burmese language as an example, a Burmese word is usually composed of one or more units and each unit is usually composed of at least one consonant letter or one consonant letter with one or more vowel notations. One unit makes one sound. Herein, a “word” has a complete meaning and consists of one or more “unit”, and a “unit” sometimes has a complete meaning but sometimes may not, and consists of one consonant letter and at least one vowel notation. It has to be noted that, sometimes only one consonant letter without any vowel notation may make a unit or even a word. Moreover, a consonant letter itself is also usually used as a vowel notation.

Furthermore, it has to be noted that, there are several exceptional words in Burmese which are commonly used. Each of the exceptional words is not composed of any of the prescriptive consonant letters and the prescriptive vowel notations. Therefore, the exceptional words cannot be input by using the consonant letters and the vowel notations, and the exceptional words must be embedded in the inputting system in advance.

FIG. 1 shows a Burmese word which pronounces “myan-mar-naing-ngan” (makes four sounds) and means “Burma country”. The reference C indicates a consonant letter and the reference V indicates a vowel notation. Herein the Burmese word shown in FIG. 1 includes four units U1, U2, U3, U4 and each unit has a consonant letter, wherein from left to right, the consonant letter C of the first unit U1 is accompanied with three vowel notations V, the consonant letter C of the second unit U2 is accompanied with one vowel notation V, the consonant letter C of the third unit U3 is accompanied with four vowel notations V, and the consonant letter C of the fourth unit U4 is accompanied with one vowel notations. As such, a user needs to press 19 times on the keyboard to input that one Burmese word. Accordingly, there is quite a demand of a user-friendly word inputting system for users in Southeast Asia countries such as Burma, Thailand, Laos, Cambodia or the like, who use that kind of segmental writing system.

### SUMMARY OF THE INVENTION

One objective of the present invention is to provide an electronic device for a segmental writing. The electronic device comprises a touch screen. The touch screen is configured to: receive a first touch signal of touching a consonant key; display at least one predicted units in response to the first touch signal; receive a second touch signal of touching an expanding key in a temporary display region; display the predicted units in response to the second touch signal; receive a third touch signal of touching one of the predicted units; and display the touched predicted unit in response to the third touch signal.

Another objective of the present invention is to provide an input method for a segmental writing of an electronic device. The electronic device comprises a touch screen. The input method comprises: (a) receiving a first touch signal of touching a consonant key by the touch screen; (b) displaying at least one predicted units in response to the first touch signal by the touch screen; (c) receiving a second touch signal of touching an expanding key in a temporary display region by the touch screen; (d) displaying the predicted units in response to the second touch signal by the touch screen; (e) receiving a third touch signal of touching one of the predicted units by the touch screen; and (f) displaying the touched predicted unit in response to the third touch signal by the touch screen.

According to the above descriptions, the present invention includes not only a complete keyboard including the consonant keys and vowel notation keys for imputing words by using an ordinary spelling method, but also includes a keyboard including the portion-of-word keys, wherein when the user touches one of the portion-of-word keys, a plurality of word predictions or commonly used terms are further displayed. Then, the user can touch the desired word prediction. Therefore, the present invention provides a user-friendly word inputting system for users in Southeast Asia countries such as Burma, Thailand, Laos, Cambodia or the like, who use that kind of segmental writing system. By using the present invention, since the total times to touch the touch screen can be significantly reduced, the user can save time and the electronic device can also be protected from the touch screen thereof being heavily used.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a Burmese word which pronounces “myan-mar-naing-ngan” and means “Burma country”.

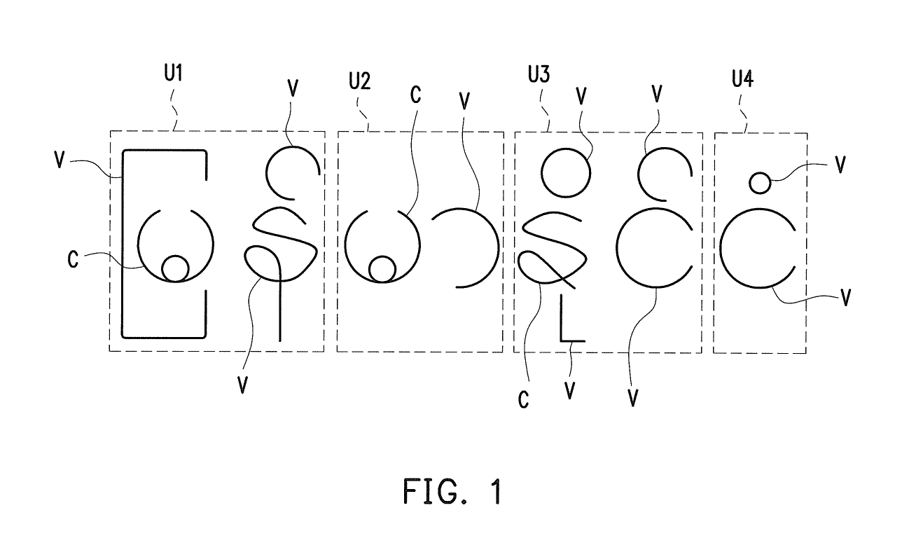

FIG. 2A shows a schematic view of a user interface according to an embodiment of the present invention.

FIG. 2B shows a schematic view of the user interface when a consonant key of FIG. 2A is touched and the expanding key is touched.

FIG. 3 shows a schematic view of the user interface when the word-word switching key is touched and the keyboard of FIG. 2 is changed according to an embodiment of the present invention.

FIG. 4 shows a schematic view of the user interface when a Burmese number key of FIG. 3 is touched according to the embodiment of the present invention.

FIG. 5 shows a schematic view of the user interface when one of the portion-of-word keys of FIG. 3 is touched according to the embodiment of the present invention.

FIG. 6 shows a schematic view of the user interface when the number-word switching key of FIG. 2A or FIG. 3 is touched according to the embodiment of the present invention.

FIG. 7 shows a schematic view of the user interface when the number-symbol switching key NS of FIG. 6 is touched according to the embodiment of the present invention.

FIG. 8 shows a schematic view of the user interface when the number-word switching key of FIG. 2A or FIG. 3 is touched according to the embodiment of the present invention.

FIG. 9 shows a schematic view of the user interface when the number-symbol switching key NS of FIG. 8 is touched according to the embodiment of the present invention.

### DESCRIPTION OF THE EMBODIMENTS

In the following, the present invention is described in detail in accordance with the drawings. An electronic device and an input method thereof relates to a segmental writing system. The electronic device comprises a touch screen. A software keypad region displayed by a display region of the touch screen is provided in the present invention. The touch screen may display an interface for users to enter messages. The user interface is suitable for an electronic device such as a smart phone, a pad or the like, for example. However, the user interface in the present invention mainly refers to an abugida which is a segmental writing system. It is not limited that the user interface of the present invention is only used in message input. In this specification, the user interface for inputting message in Burmese language is illustrated as an example.

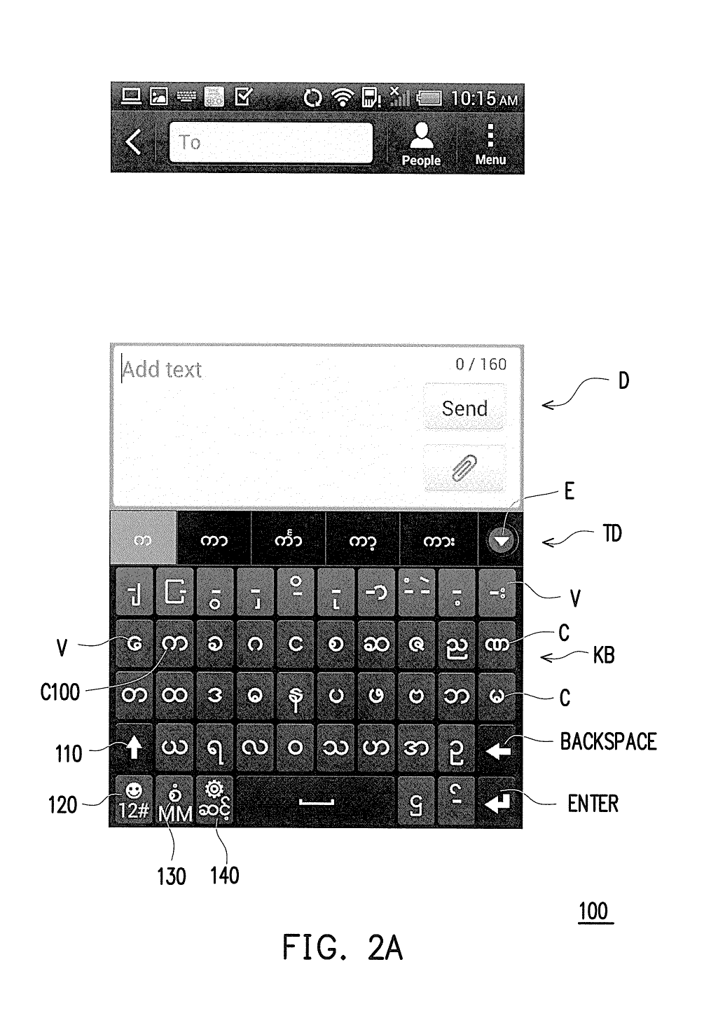

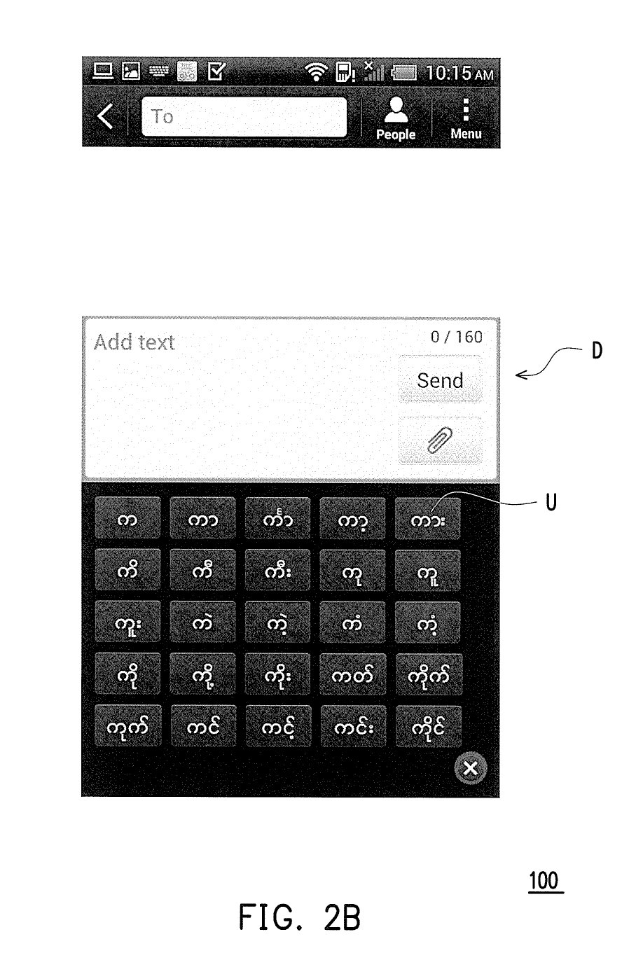

FIG. 2A shows a schematic view of a user interface according to an embodiment of the input method of the present invention. FIG. 2B shows a schematic view of the user interface when a consonant key of FIG. 2A is touched and the expanding key is touched. The user interface 100 includes a software keypad region KB, a temporary display region TD and a display region D. The display region D displays a corresponding word or phrase when one or more of the keys are touched. The software keypad region KB includes a plurality of word keys having a first page and a second page and the word keys are arranged in rows and columns. The first page of the word keys include a plurality of consonant keys C, a plurality of vowel notation keys V, a word-word switching key 110, a number-word switching key 120, a language switching key 130, an exceptional-word key 140, a backspace key BACKSPACE and an enter key ENTER.

In general, words can be input by touching the consonant keys C and the vowel notation keys V. When the user correspondingly touches the consonant keys C and the vowel notation keys V, the desired word is displayed in the display region D. More specifically, when the user touches one consonant key C (such as C100 as shown in FIG. 2A), a plurality of predicted units corresponding to the touched consonant key C100 may be displayed in the temporary display region TD. The user can expand the temporary display region TD by touching an expanding key E so that all the units corresponding to the touched consonant key C100 are displayed as shown in FIG. 2B. Then, the user can select the units U as he/she likes. On the other hand, instead of selecting a unit from the displayed units U, the user can also further input the vowel notation keys V to construct a word he/she wants. Each of the consonant keys C is embedded a plurality of units U in advance, in order to assist the user for saving time.

On the other hand, the exceptional words which cannot be spelled out by the consonant keys C and the vowel notation keys V can be input by touching the exceptional-word key 140. When the exceptional-word key 140 is touched, a plurality of exceptional words embedded in advance are displayed in the temporary display region TD. Then the user can choose to touch any of the exceptional words displayed in the temporary display region TD. Further, if the expanding key E displayed in the temporary display region TD is touched, then all of the embedded exceptional words corresponding to the touched exceptional-word key 140 are displayed.

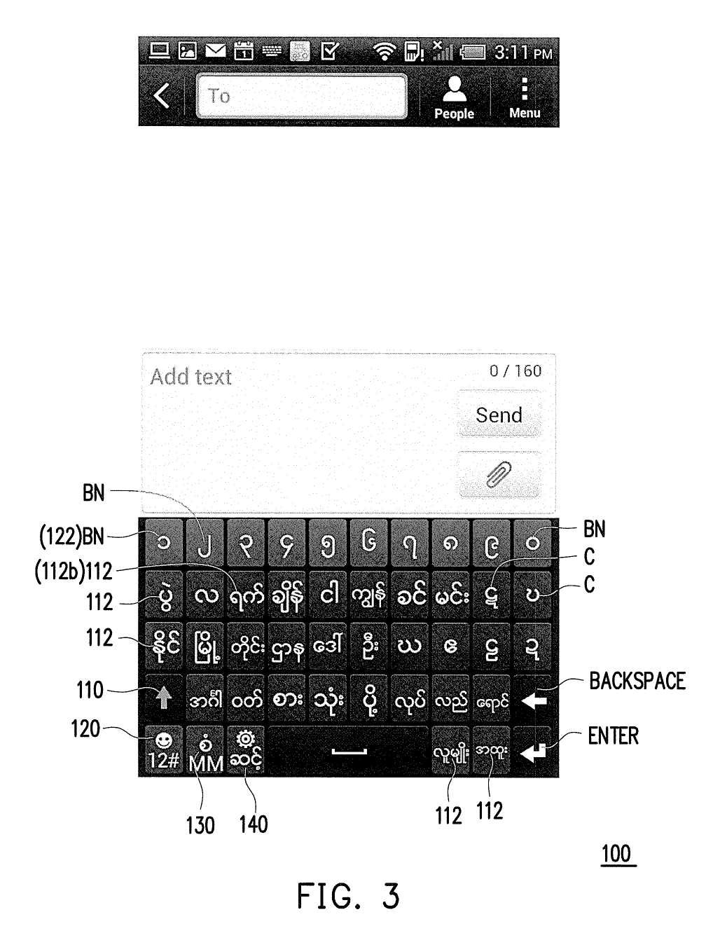

FIG. 3 shows a schematic view of the user interface when the word-word switching key is touched and the keyboard of FIG. 2A is changed according to an embodiment of the present invention. The word-word switching key 110 is for switching the keyboard, so that the keyboard is switched between the first page and the second page of the word keys. Particularly, if the word-word switching key 110 is touched, the scene of the keyboard of FIG. 2A is changed to the scene of the keyboard of FIG. 3, i.e., the first page of the word keys is changed to the second page of the word keys. The second page of the word keys as shown in FIG. 3 includes a plurality of keys arranged in rows and columns. The keys include a plurality of consonant keys C which are not included in the keyboard of FIG. 2A, a plurality of Burmese number keys BN, a plurality of portion-of-word keys 112, the word-word switching key 110, the number-word switching key 120, the language switching key 130, the exceptional-word key 140, the backspace key BACKSPACE and the enter key ENTER. The language switching key 130 is to switch the language to be input, for example, Burmese to English, or Burmese to Chinese. Specifically, the user can change the language to be input, such as from Burmese to English or Burmese to Chinese as required, by just touching the language switching key 130. As such, the user interface 100 can be user friendly.

In Burmese language, there are some words or phrases which are usually used in a sentence, such as expletive words. Almost all of the usages of the expletive words in a declarative sentence, an imperative sentence, an interrogative sentence and an exclamatory sentence in Burmese language are fixed. Therefore, in this embodiment, the plurality of portion-of-word keys 112 includes keys for commonly used expletive words. More specifically, if one of the portion-of-word keys 112 corresponding to one commonly used expletive word is touched, then all of the embedded word predictions corresponding to the touched commonly used expletive word are displayed. Then, the user can choose to touch any of the displayed word predictions. Accordingly, the user can greatly save time when using the user interface 100 of the present invention to input a message or a sentence.

Moreover, in the embodiment, the plurality of portion-of-word keys 112 also include keys for other expressions, such as date expressions, expressions for names of places or cities, expressions for “I”, expressions for “you”, and the like. Herein, as for the key of date expressions, a plurality of word predictions to express date in Burmese language are embedded in the user interface 100 according to the embodiment of the present invention. Still, as for the key of name of place or city expressions, a plurality of word predictions to express names of places or cities in Burma are embedded in the user interface 100 according to the embodiment of the present invention. By the way, in Burmese language, some words come from Pali language, especially some names of city, expressions about Buddhism, and so on. The spelling of the word may become difficult if it is concerning about Pali language. Therefore, the key of name of places or cities may advantage the user who uses Burmese language for inputting the name of city in Burma. Furthermore, as for the key of expressions for “I”, a plurality of word predictions to express “I” in Burmese language are embedded in the user interface 100 according to the embodiment of the present invention. Since there are more than five kinds of different expressions for “I” in Burmese language, and the expressions are different depending on the conditions such as the person who is speaking and the person who is spoken to, this designation greatly advantage the user who use Burmese language. Similarly, as for the key of expressions for “you”, a plurality of word predictions to express “you” in Burmese language are embedded in the user interface 100 according to the embodiment of the present invention. It should be noted that, the present invention is not limited that only the aforementioned keys are included in the portion-of-word keys 112. In other embodiments, the portion-of-word keys 112 may include keys for other expressions.

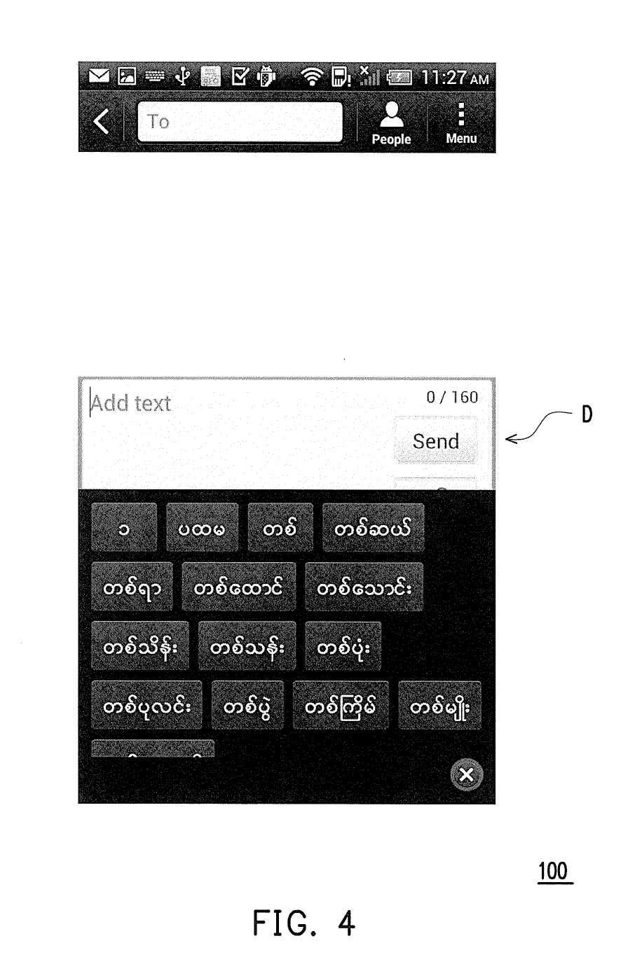

FIG. 4 shows a schematic view of the user interface when a Burmese number key of FIG. 3 is touched according to the embodiment of the present invention. As shown in FIG. 3, the Burmese number keys BN include numbers of 0 to 9 in Burmese. It would take the user a pretty much time to input a number by spelling method (touching the consonant keys C and the vowel notation keys V) if the user would like to express that number by “words”. Thus, in the embodiment, each of the Burmese number keys BN includes a plurality of word predictions or commonly used terms embedded in advance.

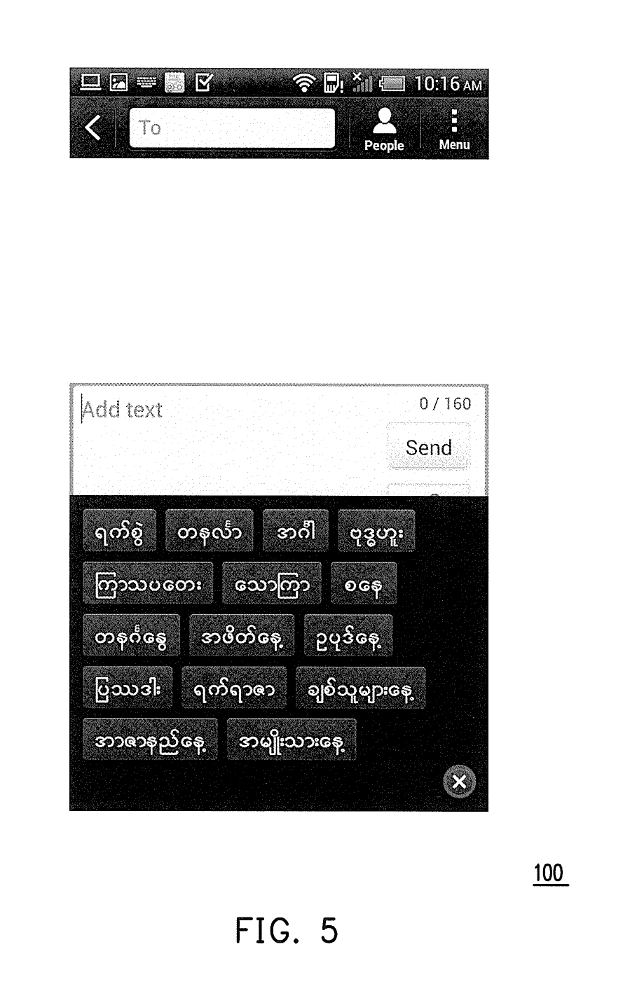

In general, the writing of number in Burmese language is complicated and quite tedious to input. For example, taking the number “1” in Burmese as an example, the expressions of first, ten, one hundred, one thousand and so on are embedded therein for the sake of conveniently inputting. Similarly, as shown in FIG. 4, when the user inputs “1” (the element symbol is shown as 122 in FIG. 3) of the Burmese number keys BN, then all the embedded word predictions or commonly used terms corresponding to the touched Burmese number key BN (122) of “1” are displayed as shown in FIG. 5. In this embodiment, the user can touch-drag the screen to see all of the embedded word predictions. Accordingly, the user can conveniently select the desired word to be displayed in the display region D by touching the word prediction.

In other embodiments which are not shown in figures, if the predicted words or commonly used terms are too many, the predicted words or commonly used terms can be displayed as a list and occupy the whole page of the screen. Herein the whole page of the screen means the list of the predicted words or commonly used terms can be listed in all of the display region D, the temporary display region TD and the software keypad region KB. This designation would advantage the users who use a segmental writing system in which words are usually in a very long term. The displayed list of predicted words or commonly used terms may include a return key to return to the previous keyboard image. Alternatively, the displayed list of predicted words or commonly used terms may be designed for the user to touch-drag to view all the embedded commonly used terms.

FIG. 5 shows a schematic view of the user interface when one of the portion-of-word keys of FIG. 3 is touched according to the embodiment of the present invention. Each of the portion-of-word keys 112 includes a plurality of word predictions or commonly used terms embedded in advance. In general, the segmental writing in Burmese language is sometimes too complicated and quite tedious to input. For example, taking the “date expressions” in Burmese as an example, the expressions of Sunday, Monday and so on, Burmese first month, Burmese second month and so on are embedded therein for the sake of conveniently inputting. Similarly, as shown in FIG. 5, when the user inputs “date” (the element symbol is shown as 112b in FIG. 3) of the portion-of-word keys 112 is touched, then all the embedded word predictions or commonly used terms corresponding to the touched portion-of-word key 112b of “date” are displayed. In this embodiment, the user can touch-drag the screen to see all of the embedded word predictions. Accordingly, the user can conveniently select the desired word to be displayed in the display region D by touching the word prediction.

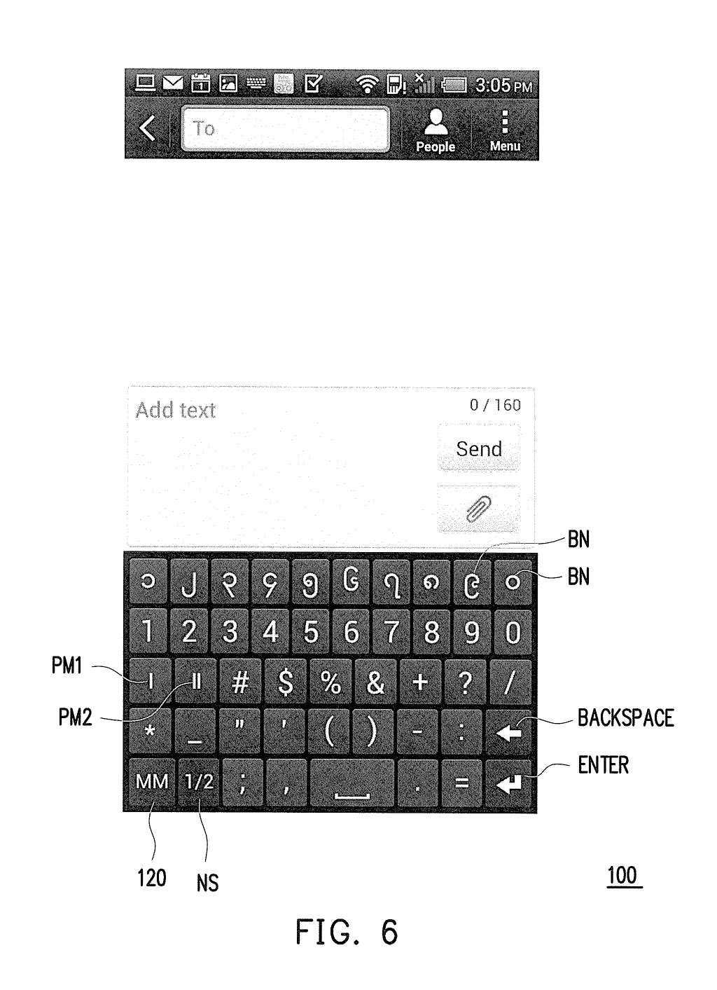

FIG. 6 shows a schematic view of the user interface when the number-word switching key of FIG. 2A or FIG. 3 is touched according to the embodiment of the present invention. In this embodiment, in order to improve the convenience of inputting method, the software keypad region KB of the user interface includes a number-word switching key 120, as shown in FIG. 2A or FIG. 3. When the number-word switching key 120 is touched, the keyboard including consonant keys V and vowel notation keys V is changed into a keyboard including a plurality of Burmese number keys BN, a plurality of Arabic number keys, a plurality of symbol keys such as “*”, “#”, “@”, “$”, “(“, ”)”, “-”, and so on, the number-word switching key 120, a number-symbol switching key NS, the backspace key BACKSPACE and the enter key ENTER. In this embodiment, since the Burmese number keys which are numbers of 0 to 9 in Burmese and the Arabic number keys which are numbers of 0 to 9 in Arabic are both included in the keyboard, the users can choose the language of numbers as they want. Moreover, in this embodiment, in order that the user can further input variety of symbols, another keyboard including a plurality of symbol keys arranged in rows and columns is displayed by touching the number-symbol switching key NS shown in FIG. 6.

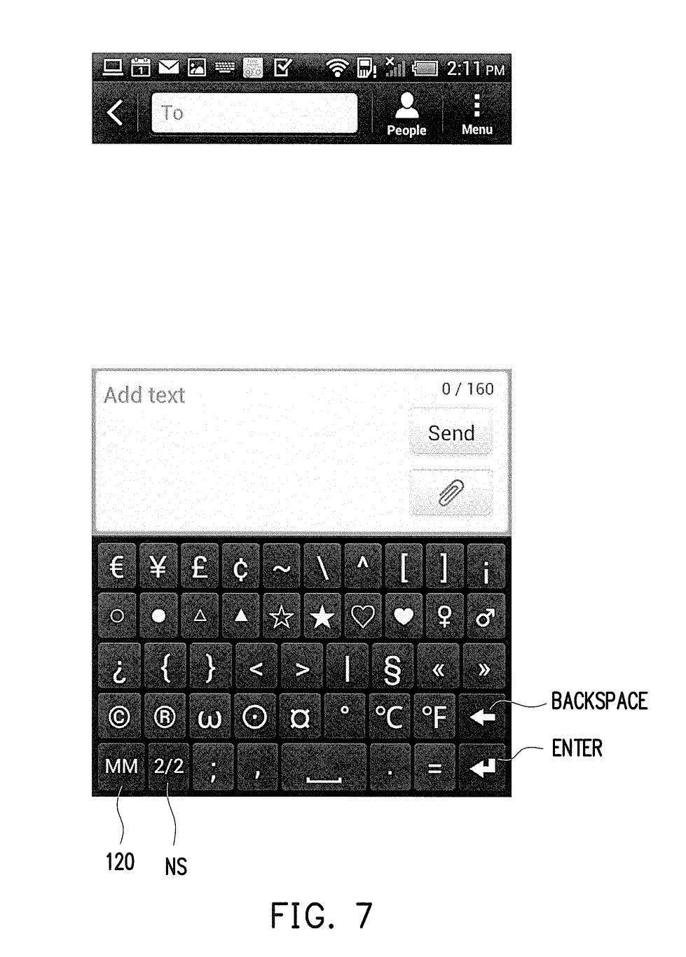

FIG. 7 shows a schematic view of the user interface when the number-symbol switching key NS of FIG. 6 is touched according to the embodiment of the present invention. As shown in FIG. 7, in addition to containing the plurality of symbol keys, the number-word switching key 120 for the user capable of switching to the keyboard including consonant keys C and vowel notation keys V whenever necessary, the number-symbol switching key NS, the backspace key BACKSPACE and the enter key ENTER are also included.

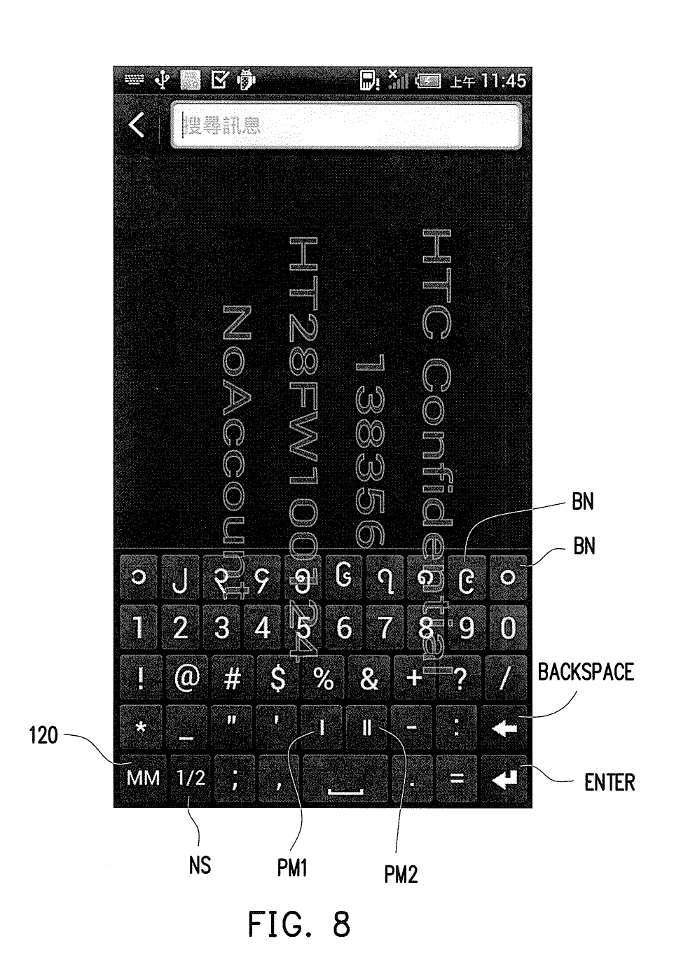

FIG. 8 shows a schematic view of the user interface when the number-word switching key of FIG. 2A or FIG. 3 is touched according to the embodiment of the present invention. In this embodiment, in order to improve the convenience of inputting method, the software keypad region KB of the user interface includes a number-word switching key 120, as shown in FIG. 2A or FIG. 3. When the number-word switching key 120 is touched, the keyboard including consonant keys V and vowel notation keys V is changed into a keyboard including a plurality of Burmese number keys BN, a plurality of Arabic number keys, a plurality of symbol keys such as “*”, “#”, “@”, “$”, “(“, ”)”, “-”, and so on, the number-word switching key 120, a number-symbol switching key NS, the backspace key BACKSPACE and the enter key ENTER. In this embodiment, since the Burmese number keys which are numbers of 0 to 9 in Burmese and the Arabic number keys which are numbers of 0 to 9 in Arabic are both included in the keyboard, the users can choose the language of numbers as they want. Moreover, in this embodiment, in order that the user can further input variety of symbols, another keyboard including a plurality of symbol keys arranged in rows and columns is displayed by touching the number-symbol switching key NS shown in FIG. 8.

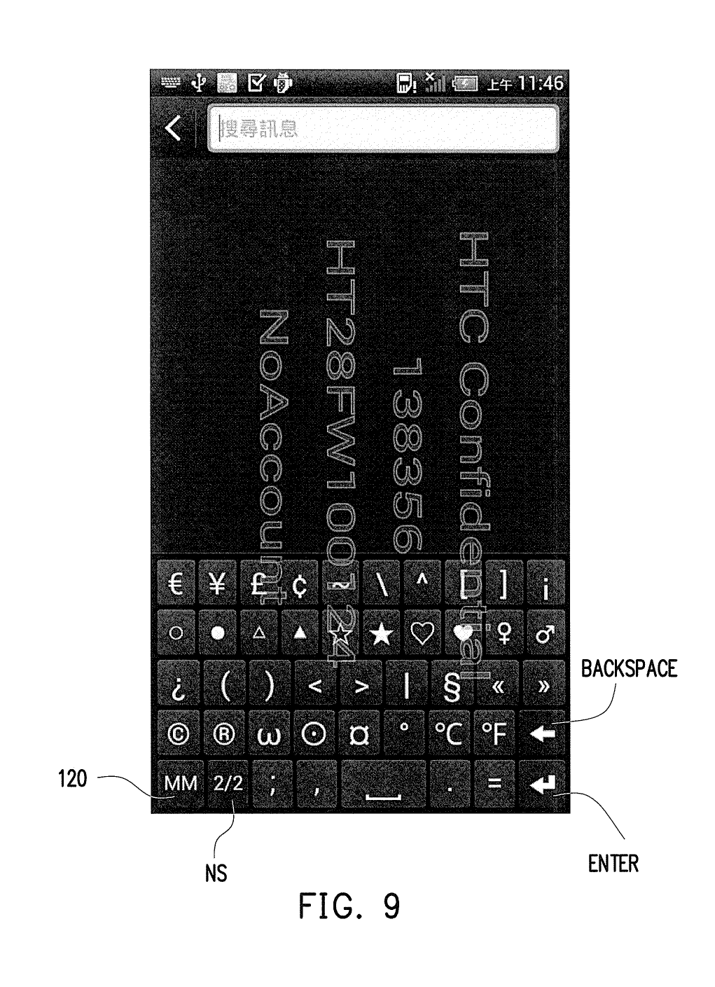

FIG. 9 shows a schematic view of the user interface when the number-symbol switching key NS of FIG. 8 is touched according to the embodiment of the present invention. As shown in FIG. 9, in addition to containing the plurality of symbol keys, the number-word switching key 120 for the user capable of switching to the keyboard including consonant keys C and vowel notation keys V whenever necessary, the number-symbol switching key NS, the backspace key BACKSPACE and the enter key ENTER are also included.

It should be noted that, in Burmese writing, punctuation marks are different from those of other language writing. In order to provide the user a complete inputting system, some Burmese punctuation marks are included in the plurality of symbol keys shown in FIGS. 6 and 8, such as the key PM1 and the key PM2. Herein, the key PM1 is equivalent to “comma” in English and the key PM1 is equivalent to “full stop” in English. Accordingly, the user interface 100 can be user friendly. In other words, the user can conveniently input a phrase or sentence including a combination of the Arabic numbers, Burmese words, and Burmese punctuation marks by using the user interface 100. Namely, the user needs not to be out from the Burmese input system when he/she needs to input some Arabic numbers or symbols during the input method of Burmese language.

In other embodiments which are not shown in figures, the user can also edit the list of word predictions or commonly used terms corresponding to each of the keys of the keyboard. More specifically, the user can edit or input the list of commonly used terms according to any expletive word keys as required. Then, the edited commonly used terms may be stored and displayed when the user touches the corresponding portion-of-word key 112.

In light of the foregoing, in the present invention, the user interface includes not only a complete keyboard including the consonant keys and vowel notation keys for imputing words by using an ordinary spelling method, but also the user interface includes a keyboard including the portion-of-word keys, wherein when the user touches one of the portion-of-word keys, a plurality of word predictions or commonly used terms are further displayed. Then, the user can touch the desired word prediction. Therefore, the user interface of the present invention provides a user-friendly word inputting system for users in Southeast Asia countries such as Burma, Thailand, Laos, Cambodia or the like, who use that kind of segmental writing system. By using the user interface of the present invention, since the total times to touch the touch screen can be significantly reduced, the user can save time and the portable device can also be protected from the touch screen thereof being heavily used.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device for a segmental writing, comprising:
a touch screen, being configured to:
receive a first touch signal of touching a consonant key;
display at least one predicted units in response to the first touch signal;
receive a second touch signal of touching an expanding key in a temporary display region;
display the predicted units in response to the second touch signal;
receive a third touch signal of touching one of the predicted units; and
display the touched predicted unit in response to the third touch signal.

2. The electronic device according to claim 1, wherein the touch screen is further configured to receive at least one fourth touch signal of touching at least one vowel notation key, and display at least one word prediction in response to the first touch signal and the at least one fourth touch signal.

3. The electronic device according to claim 1, wherein a plurality of word keys are arranged in a first page and a second page at least, the touch screen is further configured to:
receive a fifth touch signal of touching a word-word switching key; and
switch between the first page and the second page in response to the fifth touch signal, wherein the second page at least comprises a plurality of portion-of-word keys and a plurality of number keys.

4. The electronic device according to claim 3, wherein the touch screen is further configured to:
receive a sixth touch signal of touching one of the plurality of portion-of-word keys; and
display a plurality of word predictions in response to the sixth touch signal.

5. The electronic device according to claim 3, wherein the touch screen is further configured to:
receive a seventh touch signal of touching one of the plurality of number keys; and
display a plurality of word predictions in response to the seventh touch signal, wherein the number keys comprise Burmese number keys.

6. The electronic device according to claim 3, wherein the touch screen is further configured to:
receive an eighth touch signal of touching a number-word switching key; and
switch between a word keypad and a number keypad in response to the eighth touch signal, wherein the word keypad comprises the plurality of word keys and the number keypad comprises a plurality of number keys and a plurality of symbol keys.

7. The electronic device according to claim 6, wherein the number keypad further comprises a number-symbol switching key, the touch screen is further configured to switch between two pages of the number keys and the symbol keys by the touch screen.

8. The electronic device according to claim 6, wherein the number keys comprise a plurality of Burmese number keys and a plurality of Arabic number keys.

9. The electronic device according to claim 6, wherein the symbol keys comprise a plurality of Burmese punctuation-mark-keys and a plurality of symbols keys.

10. The electronic device according to claim 1, wherein the touch screen is further configured to:
receive a ninth touch signal of touching a language switching key; and
switch among a Burmese inputting keypad, an English inputting keypad and a Chinese inputting keypad in response to the ninth touch signal.

11. An input method for a segmental writing of an electronic device, the electronic device comprising a touch screen, the input method comprising:
(a) receiving a first touch signal of touching a consonant key by the touch screen;
(b) displaying at least one predicted units in response to the first touch signal by the touch screen;
(c) receiving a second touch signal of touching an expanding key in a temporary display region by the touch screen;
(d) displaying the predicted units in response to the second touch signal by the touch screen;
(e) receiving a third touch signal of touching one of the predicted units by the touch screen; and
(f) displaying the touched predicted unit in response to the third touch signal by the touch screen.

12. The input method according to claim 11, further comprising a step of receiving at least one fourth touch signal of touching at least one vowel notation key by the touch screen, the step (b) is a step of displaying at least one word prediction in response to the first touch signal and the at least one fourth touch signal by the touch screen.

13. The input method according to claim 11, wherein a plurality of word keys are arranged in a first page and a second page at least, the input method further comprises:
receiving a fifth touch signal of touching a word-word switching key by the touch screen; and
switching between the first page and the second page in response to the fifth touch signal by the touch screen, wherein the second page at least comprises a plurality of portion-of-word keys and a plurality of number keys.

14. The input method according to claim 13, further comprising:
receiving a sixth touch signal of touching one of the plurality of portion-of-word keys by the touch screen; and
displaying a plurality of word predictions in response to the sixth touch signal by the touch screen.

15. The input method according to claim 13, further comprising:
receiving a seventh touch signal of touching one of the plurality of number keys by the touch screen; and
displaying a plurality of word predictions in response to the seventh touch signal by the touch screen, wherein the number keys comprise Burmese number keys.

16. The input method according to claim 13, further comprising:
receiving an eighth touch signal of touching a number-word switching key by the touch screen; and
switching between a word keypad and a number keypad in response to the eighth touch signal by the touch screen, wherein the word keypad comprises the plurality of word keys and the number keypad comprises a plurality of number keys and a plurality of symbol keys.

17. The input method according to claim 16, wherein the number keypad further comprises a number-symbol switching key, the input method further comprises a step of switching between two pages of the number keys and the symbol keys by the touch screen.

18. The input method according to claim 16, wherein the number keys comprise a plurality of Burmese number keys and a plurality of Arabic number keys.

19. The input method according to claim 16, wherein the symbol keys comprise a plurality of Burmese punctuation-mark-keys and a plurality of symbols keys.

20. The input method according to claim 11, further comprising:
receiving a ninth touch signal of touching a language switching key by the touch screen; and
switching among a Burmese inputting keypad, an English inputting keypad and a Chinese inputting keypad in response to the ninth touch signal by the touch screen.
